(19) United States
(12) Patent Application Publication
(10) Pub. No.: US 2025/0115310 A1
(43) Pub. Date: Apr. 10, 2025

(54) VEHICLE FRONT PORTION STRUCTURE

(71) Applicants: TOYOTA JIDOSHA KABUSHIKI KAISHA, Toyota-shi (JP); AISIN CORPORATION, Kariya (JP)

(72) Inventors: Yoshiki HONMA, Toyota-shi (JP); Toshio MURATA, Toyota-shi (JP); Kazuya MATSUMOTO, Kariya-shi (JP)

(21) Appl. No.: 18/822,282

(22) Filed: Sep. 2, 2024

(30) Foreign Application Priority Data
Oct. 5, 2023 (JP) 2023-173882

(51) Int. Cl. B62D 35/02

(52) U.S. Cl. CPC B62D 35/02

(57) ABSTRACT

A vehicle front portion structure, includes: a framework member structuring a portion of a vehicle lower side of a vehicle body front portion, the framework member extending in a vehicle front-rear direction; a flow-straightening member disposed at a vehicle front side of a front wheel, the flow-straightening member being turnable by being driven between a first state in which the flow-straightening member is turned furthest toward a vehicle front side and a second state in which the flow-straightening member is turned furthest toward a vehicle rear side; and a driving unit configured to drive the flow-straightening member, the driving unit being supported by the framework member at a vehicle upper side relative to the framework member.

### CROSS-REFERENCE TO RELATED APPLICATION

This application claims priority under 35 USC 119 from Japanese Patent Application No. 2023-173882, filed Oct. 5, 2023, the disclosure of which is incorporated by reference herein in its entirety.

### BACKGROUND

### Technical Field

The present disclosure relates to a vehicle front portion structure.

### Related Art

Japanese Patent Application Laid-Open (JP-A) No. 2021-075257 discloses an invention relating to a skirt apparatus for a vehicle. In this skirt apparatus for a vehicle, a skirt (a flow-straightening member) may attain a deployed position and a stowed position by being driven by an actuator (a driving unit).

In the conventional technology mentioned above, when the skirt comes into contact with an obstacle on the road, a force from the obstacle pushing the skirt may cause the skirt to withdraw from the deployed position.

### SUMMARY

However, although the skirt may be protected from an obstacle on the road as described above, there is no structure recited in JP-A No. 2021-075257 to protect the actuator from an obstacle on the road, a flying stone or the like during running of the vehicle. That is, driving of the skirt might be affected by an object on the road.

In consideration of the circumstances described above, the present disclosure provides a vehicle front portion structure that may reduce effects on driving of a flow-straightening member from objects on the road during running of the vehicle.

A vehicle front portion structure according to a first aspect includes: a framework member structuring a portion of a vehicle lower side of a vehicle body front portion, the framework member extending in a vehicle front-rear direction; a flow-straightening member disposed at a vehicle front side of a front wheel, the flow-straightening member being turnable by being driven between a first state in which the flow-straightening member is turned furthest toward a vehicle front side and a second state in which the flow-straightening member is turned furthest toward a vehicle rear side; and a driving unit configured to drive the flow-straightening member, the driving unit being supported by the framework member at a vehicle upper side relative to the framework member.

According to the vehicle front portion structure according to the first aspect, a portion at the vehicle lower side of the vehicle body front portion is structured by the framework member that extends in the vehicle front-rear direction.

In the present aspect, the flow-straightening member is disposed at the vehicle front side of the front wheel. The flow-straightening member may be turned, by being driven by the driving portion, between the first state in which the flow-straightening member is turned furthest toward the vehicle front side and the second state in which the flow-straightening member is turned furthest toward the vehicle rear side.

Consequently, when the flow-straightening member is in the first state, a running wind is inhibited from striking the front wheel, and a decline in aerodynamic performance of the vehicle may be suppressed. On the other hand, when the flow-straightening member is in the second state, contact of the flow-straightening member with obstacles on the road and the like may be suppressed.

In addition, it is preferable to be able to reduce effects of flying stones, obstacles on the road and the like on both the flow-straightening member and the driving unit.

In the present aspect, because the driving unit is supported at the framework member at the vehicle upper side relative to the framework member, effects on the driving unit from flying stones, obstacles on the road and the like may be reduced compared to a structure in which a driving unit is disposed at the vehicle lower side relative to a framework member.

In a vehicle front portion structure according to a second aspect, in the vehicle front portion structure according to the first aspect, seen in the vehicle vertical direction, a portion of the driving unit is superposed with the framework member.

According to the vehicle front portion structure according to the second aspect, a portion of the driving unit is superposed with the framework member of the vehicle body as seen in the vehicle vertical direction. During running of the vehicle, the driving unit may be protected from flying stones and the like by the framework member.

In a vehicle front portion structure according to a third aspect, the vehicle front portion structure according to the first aspect or the second aspect further includes: a power conversion unit that is configured to adjust a driving force applied from the driving unit to the flow-straightening member; and a support member that supports the power conversion unit relative to the framework member, wherein: the support member is disposed at the vehicle lower side of the driving unit and, seen in the vehicle vertical direction, a portion of the support member is superposed with the driving unit.

According to the vehicle front portion structure according to the third aspect, the power conversion unit is provided and driving force applied to the flow-straightening member from the driving unit is adjusted by the power conversion unit. The power conversion unit is supported at the framework member of the vehicle body via the support member.

In the present aspect, the support member is disposed at the vehicle lower side of the driving unit and a portion of the support member is superposed with the driving unit as seen in the vehicle vertical direction. Therefore, in the present aspect, the driving unit may be protected from flying stones and the like by the support member during running of the vehicle.

A vehicle front portion structure according to a fourth aspect includes: a framework member structuring a portion of a vehicle lower side of a vehicle body front portion, the framework member extending in a vehicle front-rear direction; a flow-straightening member disposed at a vehicle front side of a front wheel, the flow-straightening member being formed of a soft resin; and a support member that supports the flow-straightening member relative to the framework member.

According to the vehicle front portion structure according to the fourth aspect, a portion at the vehicle lower side of the vehicle body front portion is structured by the framework member that extends in the vehicle front-rear direction. The flow-straightening member is supported at the framework member via the support member.

In the present aspect, the flow-straightening member is disposed at the vehicle front side of the front wheel of the vehicle. Therefore, in a state in which the vehicle is running at low speed, a running wind is inhibited from striking the front wheel, and a decline in aerodynamic performance of the vehicle may be suppressed.

On the other hand, in a state in which the vehicle is running at high speed, because the flow-straightening member is constituted with the soft resin, the flow-straightening member is affected by the running wind and deforms. In other words, in the present aspect the flow-straightening member is driven by a running wind of the vehicle running at high speed. That is, in contrast to the first aspect described above, no driving unit is used for driving of the flow-straightening member. Consequently, effects on driving of the flow-straightening member from flying stones, obstacles on the road and the like may be suppressed.

As described above, the vehicle front portion structure according to the first aspect has an effect in that the vehicle front portion structure may reduce effects on driving of the flow-straightening member from objects on the road.

The vehicle front portion structure according to the second aspect has an effect in that, during running of the vehicle, the vehicle front portion structure may protect the driving unit that drives the flow-straightening member.

The vehicle front portion structure according to the third aspect has an effect in that, during running of the vehicle, the vehicle front portion structure may protect the driving unit that drives the flow-straightening member.

The vehicle front portion structure according to the fourth aspect has an effect in that the vehicle front portion structure may reduce effects on driving of the flow-straightening member from objects on the road.

### BRIEF DESCRIPTION OF THE DRAWINGS

FIG. 1 is an elevation view showing structures of principal elements of a vehicle in which a vehicle front portion structure according to a first exemplary embodiment is employed;

FIG. 2 is a side view, seen from a vehicle width direction inner side (a view in the direction of arrow 2 in FIG. 1), showing structures of a flow-straightening apparatus attached to the vehicle in which the vehicle front portion structure according to the first exemplary embodiment is employed;

FIG. 3 is a side view, seen from the vehicle width direction inner side, showing a relationship between the flow-straightening apparatus and a front wheel of the vehicle in which the vehicle front portion structure according to the first exemplary embodiment is employed;

FIG. 4 is a plan view showing structures of the vehicle in which the vehicle front portion structure according to the first exemplary embodiment is employed;

FIG. 5 is a perspective view showing structures of a support member attached to the vehicle in which the vehicle front portion structure according to the first exemplary embodiment is employed;

FIG. 6 is an elevation view showing structures of the support member attached to the vehicle in which the vehicle front portion structure according to the first exemplary embodiment is employed;

FIG. 7 is a plan view showing structures of the support member attached to the vehicle in which the vehicle front portion structure according to the first exemplary embodiment is employed;

FIG. 8 is a plan view showing structures of a flow-straightening apparatus attached to a vehicle in which a vehicle front portion structure according to a second exemplary embodiment is employed; and

FIG. 9 is a side view, seen from the vehicle width direction inner side, showing a relationship between the flow-straightening apparatus and a front wheel of the vehicle in which the vehicle front portion structure according to the second exemplary embodiment is employed.

### DETAILED DESCRIPTION

### First Exemplary Embodiment

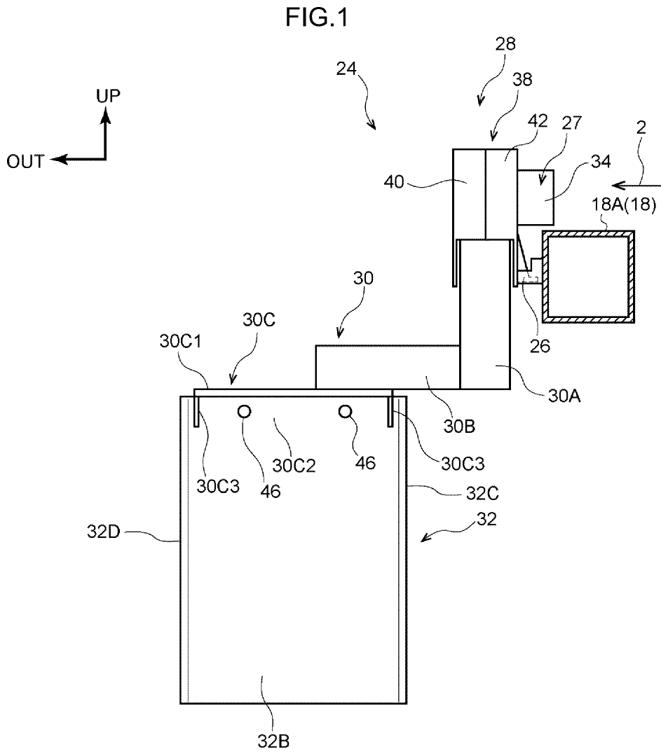

A first exemplary embodiment of a vehicle front portion structure according to the present disclosure is described using FIG. 1 to FIG. 7. An arrow FR that is shown as appropriate in the drawings indicates a vehicle front side, an arrow UP indicates a vehicle upper side, and an arrow OUT indicates a vehicle width direction outer side.

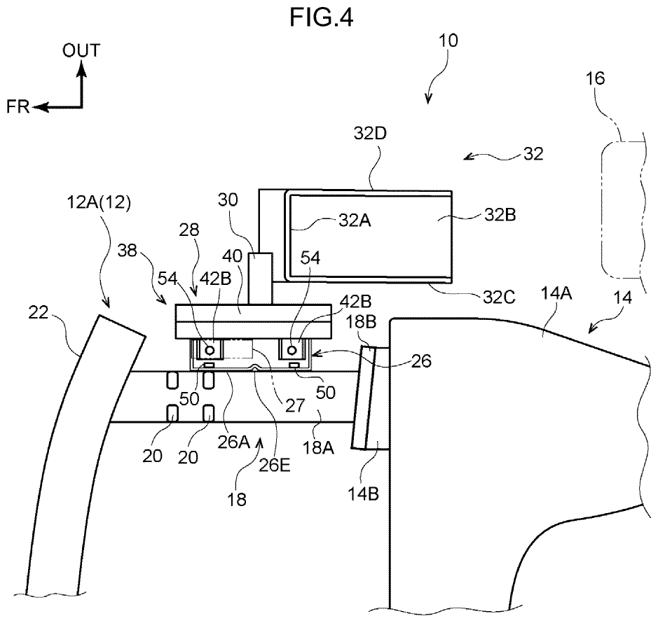

Schematic structures of a vehicle body 12 of a vehicle 10, in which the vehicle front portion structure according to the present exemplary embodiment is employed, are described using FIG. 4. In the present exemplary embodiment, the vehicle body 12 is basically structured with left-and-right symmetry. Accordingly, structures in a region at the vehicle width direction right side of the vehicle body 12 are principally described below; descriptions of structures in the region at the vehicle width direction left side are omitted as appropriate.

A power unit, which is not shown in the drawings, is disposed in a region at the vehicle front side of the vehicle body 12, that is, at a vehicle body front portion 12A. A left and right pair of front side members, which are not shown in the drawings, are disposed at both vehicle width direction sides of the power unit. The front side members structure portions of the framework of the vehicle body 12 and are each disposed with a length direction thereof in the vehicle front-and-rear direction. Suspension members 14 are disposed at the vehicle lower side of the power unit. A portion at the vehicle rear side of each suspension member 14 is fixed to a portion at the vehicle rear side of the front side member by a fastening member such as a bolt or the like, which is not shown in the drawings.

The suspension member 14 includes a main body portion 14A, which structures a principal portion of the suspension member 14, and an attachment portion 14B. A left and right pair of front suspension arms, which are not shown in the drawings, are supported by the main body portions 14A. These front suspension arms support front wheels 16.

Each attachment portion 14B is provided at a portion at the vehicle width direction outer side of the vehicle front side of the main body portion 14A. A crush box 18 that serves as a framework member is attached to the attachment portion 14B. That is, the crush box 18 structures a portion of the vehicle lower side of the vehicle body front portion 12A.

A collision absorbing portion 18A and a mounting portion 18B of the crush box 18 are integrally formed by an extruded member of an aluminum alloy. The collision absorbing portion 18A is formed in a square tube shape that extends in the vehicle front-rear direction. The mounting portion 18B is provided extending along the vehicle vertical direction at an end portion at the vehicle rear side of the collision absorbing portion 18A. The mounting portion 18B is attached to the attachment portion 14B of the suspension member 14 via an attachment member such as a bolt or the like, which is not shown in the drawings. Thus, the crush box 18 is fixed relative to the vehicle body 12.

Plural recess portions 20 are formed in a region at the vehicle front side of the collision absorbing portion 18A. The recess portions 20 extend in directions orthogonal to the vehicle front-rear direction and are recessed towards the middle of a cross section of the collision absorbing portion 18A as seen in the vehicle front-rear direction. The recess portions 20 are start points for compressive deformation of the collision absorbing portion 18A by a collision load applied from the vehicle front side.

Respective front end portions of the collision absorbing portions 18A are linked by a bumper reinforcement 22 that extends in the vehicle width direction. As an example, the bumper reinforcement 22 is structured by an extruded member of an aluminum alloy, a cross section of which as seen in the vehicle width direction is a rectangular frame-shaped chamber structure. The bumper reinforcement 22 is fixed to the front end portion of each collision absorbing portion 18A via an attachment member that is not shown in the drawings.

In each vehicle body front portion 12A structured as described above, when a collision load is applied to the bumper reinforcement 22 from the vehicle front side, the collision absorbing portion 18A of the crush box 18 compressively deforms in the vehicle front-rear direction, absorbing a portion of the collision load.

In the present exemplary embodiment, a feature of the present exemplary embodiment is that a flow-straightening member 24 is attached to the collision absorbing portion 18A of each crush box 18 via a support member 26. Structures of the flow-straightening member 24 and the support member 26, which constitute principal portions of the present exemplary embodiment, are described in detail below.

As shown in FIG. 1, the flow-straightening member 24 includes a driving unit 27, a power conversion unit 28, a driving arm 30, and a straightening plate 32 that serves as the flow-straightening member.

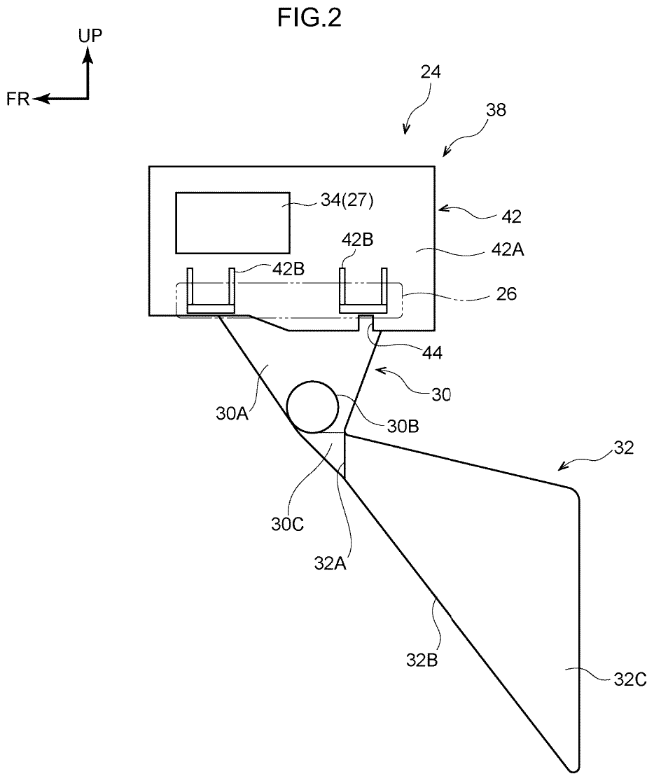

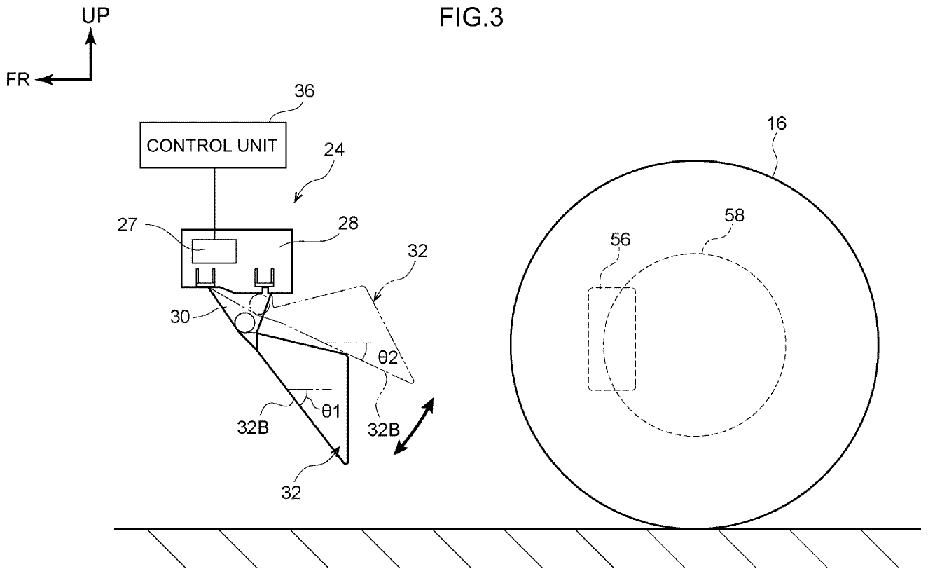

As shown in FIG. 2, the driving unit 27 includes a case 34 fabricated of resin and a motor, which is not shown in the drawings. The case 34 structures an outer shell, and the motor is disposed inside the case 34. The motor may be supplied with electric power from an electric power supply unit such as a battery or the like mounted at the vehicle 10, which is not shown in the drawings. As illustrated in FIG. 3, operations of the motor are controlled by a control unit 36 installed in the vehicle 10.

The power conversion unit 28 includes a case 38 fabricated of resin and a plural number of gears, which are not shown in the drawings. The case 38 structures an outer shell, and the gears are disposed inside the case 38. The gears convert driving force transmitted from the driving unit 27 to a suitable turning speed and torque, and transmit the driving force to the driving arm 30. That is, the power conversion unit 28 may adjust a driving force applied from the driving unit 27 to the side at which the straightening plate 32, which is described below, is provided.

The case 38 includes a case outer 40 that structures a portion at the vehicle width direction outer side thereof and a case inner 42 that structures a portion at the vehicle width direction inner side. The case 38 is formed in a box shape that is open to the vehicle lower side thereof.

More specifically, an inner side sidewall 42A structures a portion at the vehicle width direction inner side of the case inner 42. A pair of supporting leg portions 42B are provided integrally with portions of the inner side sidewall 42A at the vehicle lower side of the inner side sidewall 42A. The supporting leg portions 42B are spaced apart in the vehicle front-rear direction. The supporting leg portions 42B are supported at the support member 26, as described below.

Seen in the vehicle width direction, a slit portion 44 is provided at a portion of the inner side sidewall 42A at the vehicle lower side of the supporting leg portion 42B that is at the vehicle rear side. The slit portion 44 is open to the vehicle lower side. Also seen in the vehicle width direction, the driving unit 27 is attached by an attachment member, which is not shown in the drawings, to a portion of the inner side sidewall 42A at the vehicle upper side of the supporting leg portion 42B that is at the vehicle front side.

More specifically, as shown in FIG. 1, the driving unit 27 is disposed at the vehicle upper side relative to the collision absorbing portion 18A of the crush box 18 and, seen in the vehicle vertical direction, a vehicle width direction inner side portion of the driving unit 27 is superposed with the collision absorbing portion 18A.

The driving arm 30 includes an arm main body portion 30A, an extension portion 30B and a support piece portion 30C. A vehicle upper side portion of the arm main body portion 30A is accommodated in the case 34 of the power conversion unit 28, and the arm main body portion 30A is supported to be turnable relative to the case 34 about an axis along the vehicle width direction. The vehicle upper side portion of the arm main body portion 30A is linked with an output gear of the power conversion unit 28 via a link member, which is not shown in the drawings. When driving force is transmitted from the driving unit 27 to the power conversion unit 28, the driving arm 30 turns about the axis along the vehicle width direction.

The descriptions below continue with the assumption that the driving arm 30 is disposed in a first state in which the driving arm 30 is turned furthest toward the vehicle front side.

The extension portion 30B is formed in a circular tube shape that extends to the vehicle width direction outer side from a vehicle lower side portion of the arm main body portion 30A. The support piece portion 30C is provided integrally with the extension portion 30B at a vehicle width direction outer side portion of the extension portion 30B.

The support piece portion 30C includes an upper wall portion 30C1, a rear wall portion 30C2 and plural rib portions 30C3. The upper wall portion 30C1 structures a vehicle upper side portion of the support piece portion 30C and extends in the vehicle width direction with a plate thickness direction in the vehicle vertical direction. The rear wall portion 30C2 extends to the vehicle lower side from a peripheral edge portion at the vehicle rear side of the upper wall portion 30C1. The rib portions 30C3 extend between the upper wall portion 30C1 and the rear wall portion 30C2. The straightening plate 32 is attached to the rear wall portion 30C2.

The straightening plate 32 is formed of a resin. As shown in FIG. 4, the straightening plate 32 includes an attachment wall portion 32A, an angled wall portion 32B, an inner side wall portion 32C and an outer side wall portion 32D. The attachment wall portion 32A structures a portion at the vehicle upper side of the straightening plate 32 and extends in the vehicle width direction with a plate thickness direction in the vehicle front-rear direction. In a state in which the attachment wall portion 32A abuts against the rear wall portion 30C2 of the driving arm 30 from the vehicle rear side thereof, the attachment wall portion 32A is attached to the rear wall portion 30C2 by attaching members 46 such as bolts or the like.

As shown in FIG. 2, the angled wall portion 32B structures a main portion of the straightening plate 32 and extends to the vehicle lower-rear side from a peripheral edge portion at the vehicle lower side of the attachment wall portion 32A.

The inner side wall portion 32C structures a portion at the vehicle width direction inner side of the straightening plate 32, is provided continuously with the attachment wall portion 32A and the angled wall portion 32B, and is formed in a substantially triangular plate shape as seen in the vehicle width direction.

The outer side wall portion 32D structures a portion at the vehicle width direction outer side of the straightening plate 32, is provided continuously with the attachment wall portion 32A and the angled wall portion 32B, and is formed in a substantially triangular plate shape as seen in the vehicle width direction.

As shown in FIG. 3, the flow-straightening member 24 that is structured as described above may attain the first state and a second state (the two-dot chain lines in FIG. 3) by the driving unit 27 being controlled by the control unit 36. In the first state, the driving arm 30 and the straightening plate 32 is turned furthest toward the vehicle front side. In the second state, the driving arm 30 and the straightening plate 32 is turned furthest toward the vehicle rear side. In the present exemplary embodiment, the control unit 36 sets the flow-straightening member 24 to the first state when a running speed of the vehicle 10 is less than 70 km/h, and sets the flow-straightening member 24 to the second state when a running speed of the vehicle 10 is 70 km/h or more.

In the present exemplary embodiment, a projection area of the straightening plate 32 projected onto the front wheel 16 as seen from the vehicle front side is smaller in the second state than in the first state.

Further, an acute angle θ2 formed between the angled wall portion 32B and a line extended horizontally as seen in the vehicle width direction in the second state is smaller than an acute angle θ1 formed between the angled wall portion 32B and a line extended horizontally as seen in the vehicle width direction in the first state.

In the present exemplary embodiment, when the flow-straightening member 24 is in the first state, a running wind is inhibited from striking the front wheel 16 by the straightening plate 32. When the flow-straightening member 24 is in the second state, the running wind is straightened by the straightening plate 32 and flows along structural components of a brake apparatus, such as a brake caliper 56 and a disc rotor 58 or the like.

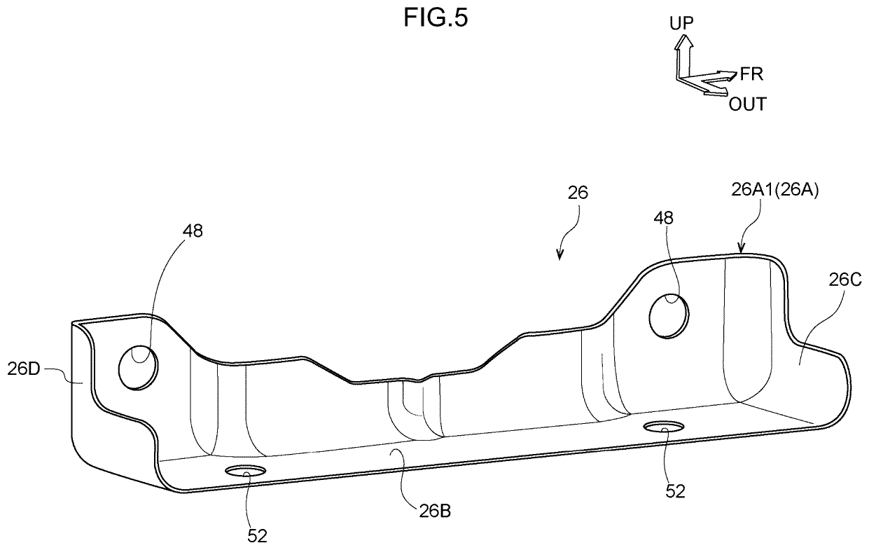

Now, structures of the support member 26 are described. As shown in FIG. 5, the support member 26 includes a side wall portion 26A, a lower wall portion 26B, a front wall portion 26C and a rear wall portion 26D. The side wall portion 26A structures a vehicle width direction inner side portion, the lower wall portion 26B structures a vehicle lower side portion, the front wall portion 26C structures a vehicle front side portion, and the rear wall portion 26D structures a vehicle rear side portion of the support member 26.

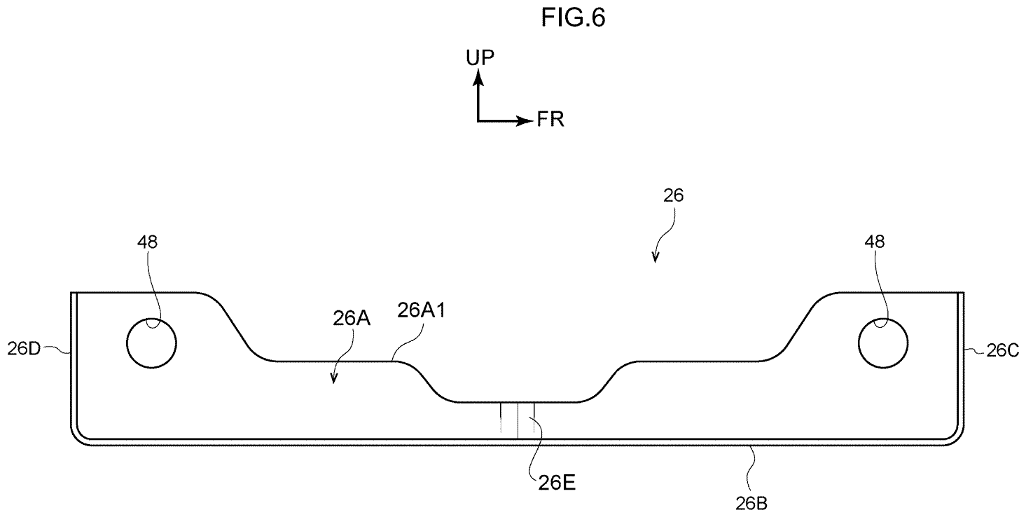

As shown in FIG. 4, the side wall portion 26A extends in the vehicle front-rear direction with a plate thickness direction in the vehicle width direction, and is arranged along the collision absorbing portion 18A of the crush box 18. As shown in FIG. 6, a height of an upper edge portion 26A1 of the side wall portion 26A is lowest at a vehicle front-rear direction central portion of the upper edge portion 26A1.

Penetrating portions 48 that penetrate in the vehicle width direction are formed in each of a vehicle front side portion and a vehicle rear side portion of the side wall portion 26A. Respective attaching members 50 such as bolts or the like are inserted into these penetrating portions 48 from the vehicle width direction outer side and fastened to weld nuts, female threaded portions or the like provided at the collision absorbing portion 18A, which are not shown in the drawings. Thus, the support member 26 is attached to the vehicle body 12 at the vehicle rear side of the bumper reinforcement 22.

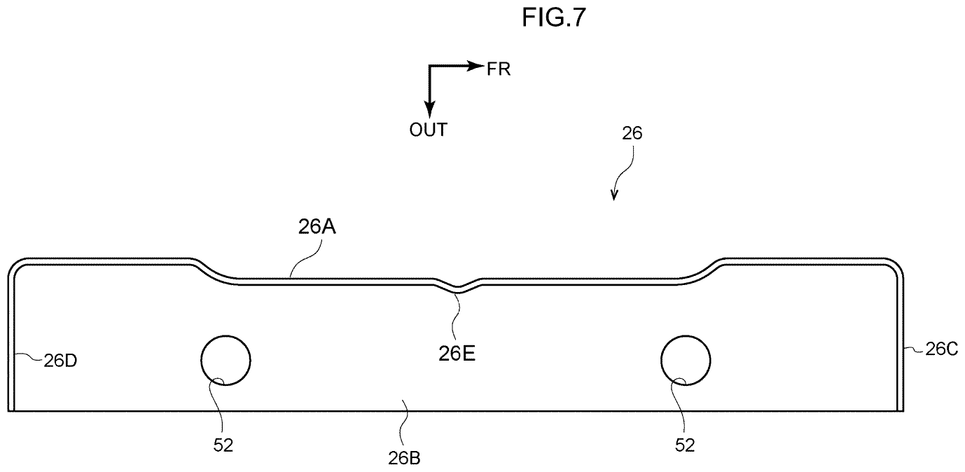

A bead portion 26E is provided at a vehicle front-rear direction central portion of the side wall portion 26A between the pair of penetrating portions 48, that is, at a vehicle front-rear direction central portion between the pair of attaching members 50. As shown in FIG. 7, seen in the vehicle vertical direction, the bead portion 26E forms a “V” shape protruding to the vehicle width direction outer side, that is, to the opposite side from the side of the side wall portion 26A at which the collision absorbing portion 18A is disposed.

The lower wall portion 26B extends in the vehicle front-rear direction with a plate thickness direction in the vehicle vertical direction. The lower wall portion 26B is continuous with a lower edge portion of the side wall portion 26A. Penetrating portions 52 that penetrate in the vehicle vertical direction are formed in each of a vehicle front side portion and a vehicle rear side portion of the lower wall portion 26B.

As shown in FIG. 4, in a state in which the supporting leg portions 42B of the power conversion unit 28 are resting on the vehicle upper side of the lower wall portion 26B, penetrating portions provided in the supporting leg portions 42B, which are not shown in the drawings, are coupled with the penetrating portions 52 by attaching members 54 such as bolts and nuts or the like. Thus, the flow-straightening member 24 is attached to the support member 26.

Returning to FIG. 5, a plate thickness direction of the front wall portion 26C is in the vehicle front-rear direction, and the front wall portion 26C is continuous with periphery edge portions at the vehicle front sides of the side wall portion 26A and the lower wall portion 26B. An outer side portion, in the vehicle width direction, of an upper edge of the front wall portion 26C has a shape that is recessed in an “L” shape. The rear wall portion 26D has a similar structure to the front wall portion 26C.

As shown in FIG. 1 and FIG. 2, the support member 26 with the structure described above is disposed at the vehicle lower side of the driving unit 27 of the flow-straightening member 24, and the support member 26 is in a state in which, seen in the vehicle vertical direction, a vehicle front side portion of the support member 26 is superposed with the driving unit 27.

A vehicle front-rear direction central portion of the support member 26 is lowest in rigidity with respect to a bending moment in the vehicle width direction. Therefore, when a collision load applied to the vehicle body 12 from the vehicle front side is applied to the support member 26 via the crush box 18, the bead portion 26E acts as a start point for a folding deformation of the side wall portion 26A and the support member 26.

### Operation and Effects of the Present Exemplary Embodiment

Operation and effects of the present exemplary embodiment are described.

As shown in FIG. 4, in the present exemplary embodiment a portion at the vehicle lower side of the vehicle body front portion 12A is structured by the crush box 18 that extends in the vehicle front-rear direction.

As shown in FIG. 3, the straightening plate 32 is disposed at the vehicle front side of the front wheel 16 and the straightening plate 32 may be turned, by being driven by the driving unit 27, between the first state that is turned furthest toward the vehicle front side and the second state that is turned furthest toward the vehicle rear side.

Consequently, when the straightening plate 32 is in the first state, a running wind is inhibited from striking the front wheel 16, and a decline in aerodynamic performance of the vehicle 10 may be suppressed. On the other hand, when the straightening plate 32 is in the second state, contact of the straightening plate 32 with obstacles on the road and the like may be suppressed.

In addition, it is preferable to be able to reduce effects of flying stones, obstacles on the road and the like on both the straightening plate 32 and the driving unit 27.

In the present exemplary embodiment, as shown in FIG. 1, the driving unit 27 is supported at the vehicle upper side relative to the crush box 18, being supported at the crush box 18 via the support member. Therefore, effects on the driving unit 27 from flying stones, obstacles on the road and the like may be reduced compared to a structure in which the driving unit 27 is disposed at the vehicle lower side relative to the crush box 18. In the present exemplary embodiment effects on driving of the straightening plate 32 from objects on the road may be reduced.

A portion of the driving unit 27 is superposed with the crush box 18 as seen in the vehicle vertical direction. The driving unit 27 may be protected from flying stones and the like by the crush box 18 during running of the vehicle 10. Therefore, the driving unit 27 that drives the straightening plate 32 may be protected during running of the vehicle 10.

In addition, the power conversion unit 28 is provided, and driving force applied to the straightening plate 32 from the driving unit 27 is adjusted by the power conversion unit 28. The power conversion unit 28 is also supported at the crush box 18, via the support member 26.

The support member 26 is disposed at the vehicle lower side of the driving unit 27, and a portion of the support member 26 is superposed with the driving unit 27 as seen in the vehicle vertical direction. Therefore, the driving unit 27 may be protected from flying stones and the like by the support member 26 during running of the vehicle 10. The driving unit 27 that drives the straightening plate 32 may be more assuredly protected during running of the vehicle 10.

### Second Exemplary Embodiment

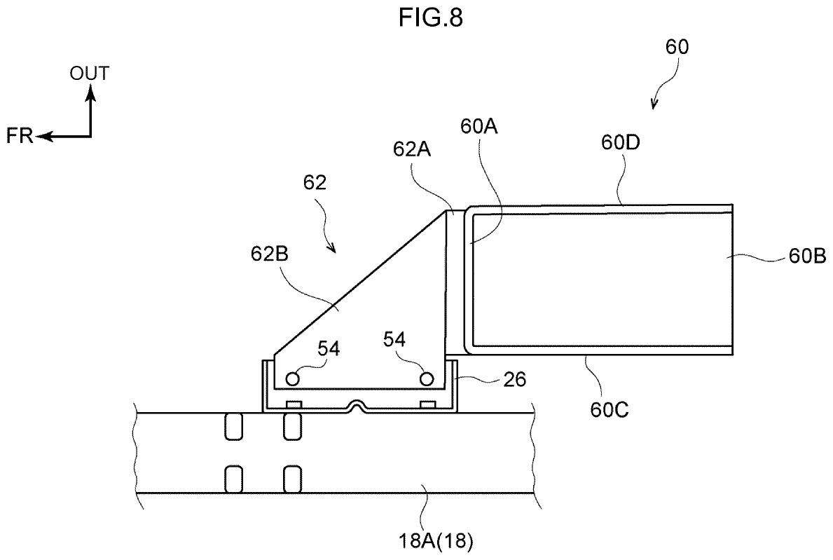

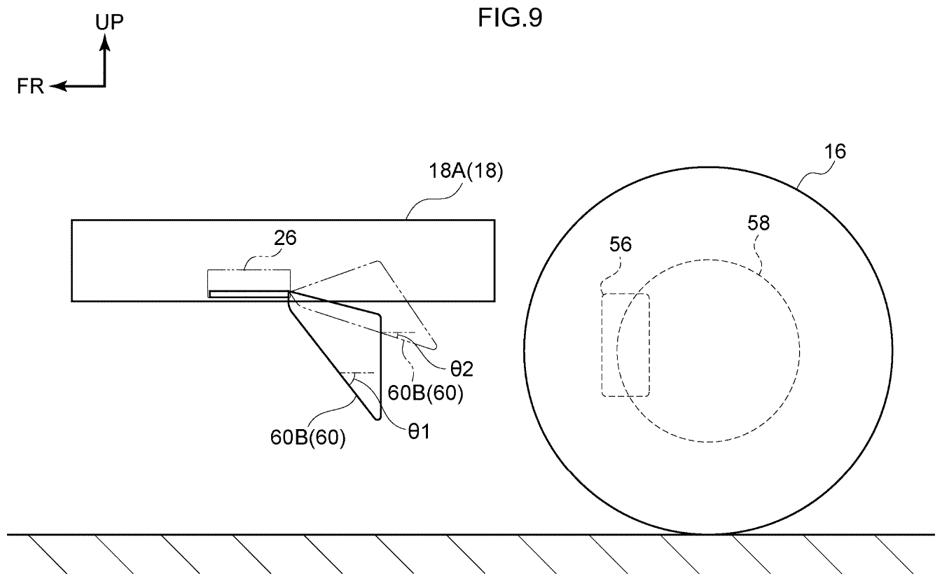

A vehicle body front portion structure according to a second exemplary embodiment of the present disclosure is described using FIG. 8 and FIG. 9. Structural elements in common with the first exemplary embodiment described above are assigned the same reference symbols, and descriptions thereof are omitted as appropriate.

The present exemplary embodiment basically has similar structures to the first exemplary embodiment described above, but a straightening plate 60 that serves as the flow-straightening member is supported at the support member 26 via a support arm 62. That is, the present exemplary embodiment differs from the first exemplary embodiment described above in not being provided with the driving unit 27 and the power conversion unit 28.

More specifically, the straightening plate 60 includes an attachment wall portion 60A, an angled wall portion 60B, an inner side wall portion 60C and an outer side wall portion 60D. The straightening plate 60 is formed in a similar shape to the straightening plate 32, but is formed of a soft resin.

The support arm 62 includes a support piece portion 62A, which has a similar structure to the support piece portion 30C according to the first exemplary embodiment, and a base plate portion 62B that extends to the vehicle front side from the support piece portion 62A and is formed in a trapezoid plate shape as seen in the vehicle vertical direction.

The straightening plate 60 is attached to the support piece portion 62A in a similar manner to the support piece portion 30C. The base plate portion 62B is attached to the support member 26 at two locations by the attaching members 54.

In the present exemplary embodiment, in a state in which the vehicle 10 is stopped, an angle between the angled wall portion 60B and a line extended horizontally as seen in the vehicle width direction is the acute angle θ1. When the running speed of the vehicle 10 reaches 70 km/h, the straightening plate 60 is resiliently deformed by the running wind of the vehicle 10 and the angle formed between the angled wall portion 60B and the line extended horizontally as seen in the vehicle width direction becomes the acute angle θ2.

In the present exemplary embodiment with the structure described above, the straightening plate 60 is disposed at the vehicle front side of the front wheel 16 of the vehicle 10. Therefore, in a state in which the vehicle 10 is running at low speed, a running wind is inhibited from striking the front wheel 16, and a decline in aerodynamic performance of the vehicle 10 may be suppressed.

On the other hand, in a state in which the vehicle 10 is running at high speed, because the straightening plate 60 is formed of the soft resin, the straightening plate 60 is affected by the running wind and deforms. In other words, in the present exemplary embodiment the straightening plate 60 is driven by a running wind of the vehicle 10 running at high speed. That is, in the present exemplary embodiment, in contrast to the first exemplary embodiment described above, the driving unit 27 is not used for driving of the straightening plate 60. Consequently, effects on driving of the straightening plate 60 from flying stones, obstacles on the road and the like may be suppressed. In the present exemplary embodiment effects on driving of the straightening plate 60 from objects on the road may be reduced.

In the exemplary embodiments described above, the straightening plate and the driving arm 30 or support arm 62 supporting the straightening plate are separate bodies. However, a straightening plate and a member supporting the straightening plate may be formed integrally of resin. A soft resin may be employed for the straightening plate and a hard resin may be employed for the driving arm 30 or support arm 62 and the like, and a component in which the straightening plate is integrated with the driving arm 30 or a component in which the straightening plate is integrated with the support arm 62 may be formed by two-color molding.

What is claimed is:

1. A vehicle front portion structure, comprising:
a framework member structuring a portion of a vehicle lower side of a vehicle body front portion, the framework member extending in a vehicle front-rear direction;
a flow-straightening member disposed at a vehicle front side of a front wheel, the flow-straightening member being turnable by being driven between a first state in which the flow-straightening member is turned furthest toward a vehicle front side and a second state in which the flow-straightening member is turned furthest toward a vehicle rear side; and
a driving unit configured to drive the flow-straightening member, the driving unit being supported by the framework member at a vehicle upper side relative to the framework member.

2. The vehicle front portion structure according to claim 1, wherein, seen in a vehicle vertical direction, a portion of the driving unit is superposed with the framework member.

3. The vehicle front portion structure according to claim 2, further comprising:
a power conversion unit that is configured to adjust a driving force applied from the driving unit to the flow-straightening member; and
a support member that supports the power conversion unit relative to the framework member, wherein:
the support member is disposed at a vehicle lower side of the driving unit, and
seen in the vehicle vertical direction, a portion of the support member is superposed with the driving unit.

4. A vehicle front portion structure, comprising:
a framework member structuring a portion of a vehicle lower side of a vehicle body front portion, the framework member extending in a vehicle front-rear direction;
a flow-straightening member disposed at a vehicle front side of a front wheel, the flow-straightening member being formed of a soft resin; and
a support member supporting the flow-straightening member relative to the framework member.
